(19) United States
(12) Patent Application Publication
(10) Pub. No.: US 2026/0184545 A1
(43) Pub. Date: Jul. 2, 2026

(54) HANDLING MACHINE COMPRISING A TANK INTENDED TO CONTAIN HYDROGEN

(71) Applicant: MANITOU BF, ANCENIS (FR)

(72) Inventors: Maurice BESSEAU, ANCENIS (FR); Xavier SCHELL, ANCENIS (FR); Valentin BREHIER, ANCENIS (FR)

(21) Appl. No.: 18/842,645

(22) PCT Filed: Mar. 1, 2023
(86) PCT No.: PCT/EP2023/055231

§ 371 Date: Aug. 29, 2024

(30) Foreign Application Priority Data
Mar. 11, 2022 (FR) 2202149

(51) Int. Cl. B66F 9/075; B60K 15/03; B60K 15/07; F17C 13/08

(52) U.S. Cl. CPC B66F 9/07518; B60K 15/07; B60K 2015/03315; F17C 13/084; F17C 2205/0103; F17C 2270/0184

(57) ABSTRACT

The invention relates to a handling machine (1) having:
a chassis (2) having a median longitudinal axis (X) and comprising two longitudinal members (6, 7) extending on either side of the median longitudinal axis (X);
a load-handling device, which is mounted so as to be able to move on the chassis (2);
a driver's cab (11), which is fastened to the chassis (2) and is positioned on a first side of the chassis (2) with respect to the median longitudinal axis (X) of the chassis (2); and
at least one tank (9, 53, 54, 55, 56), which is intended to contain hydrogen and is housed in the chassis (2), between the two longitudinal members (6, 7).

### TECHNICAL FIELD

The invention relates to the field of handling machines having a load-handling device and a tank intended to contain hydrogen.

### TECHNOLOGICAL BACKGROUND

Document U.S. Pat. No. 6,688,481 discloses a crane that has a chassis, a telescopic arm that is mounted in an articulated manner on the chassis and an electric motor that is configured to propel the crane. In one embodiment, the crane has a fuel cell system that is connected to the electric motor in order to supply the latter with electrical energy. The fuel cell system is arranged on a rear part of the chassis of the vehicle in order to form a counterweight.

Such a handling machine is not entirely satisfactory, in particular in that the abovementioned arrangement of the fuel cell system does not allow the hydrogen tank to be effectively protected against impacts, even though these constitute, along with fires, the primary causes for the tank exploding.

### SUMMARY

One idea on which the invention is based consists in proposing a handling machine comprising a tank intended to contain hydrogen and that offers enhanced safety.

According to a first object, the invention relates to a handling machine having:
a chassis having a median longitudinal axis and comprising two longitudinal members extending on either side of the median longitudinal axis;
a load-handling device, which is mounted so as to be able to move on the chassis;
a driver's cab, which is fastened to the chassis and is positioned on a first side of the chassis with respect to the median longitudinal axis of the chassis; and
at least one tank, which is intended to contain hydrogen and is housed in the chassis, between the two longitudinal members.

Thus, the arrangement of the tank in the chassis between the two longitudinal members offers, in particular, excellent protection against falling objects and lateral impacts.

According to some embodiments, such a handling machine may have one or more of the following features.

According to one embodiment, the tank is a pressurized hydrogen tank suitable for storing hydrogen at a maximum pressure of between 300 and 700 bar. According to another embodiment, the tank is a tank for storing hydrogen in the form of hydrides. According to yet another embodiment, the tank is a tank for storing hydrogen in the liquid state.

According to one embodiment, the handling machine also has hydrogen-consuming equipment, which is connected to the tank via a supply line and which is selected from among a fuel cell and a hydrogen internal combustion engine.

According to one embodiment, the handling machine comprises a casing, which is fastened to the chassis and is arranged on a second side of the chassis, opposite the first side, with respect to the median longitudinal axis and the hydrogen-consuming equipment is housed in the casing. Such an arrangement is advantageous in that it, on the one hand, allows the energy-consuming equipment to be positioned at a distance from the driver, thereby increasing their safety, and, on the other hand, allows the hydrogen-consuming equipment to be separated from the tank, thereby limiting the risk of said tank catching fire.

According to one embodiment, the supply line that connects the tank to the hydrogen-consuming equipment has a pressure regulator, the pressure regulator and also an upstream portion of the supply line that connects the pressure regulator to the tank being housed in the chassis, between the two longitudinal members. This makes it possible to ensure that the portion of the supply line that is most critical in terms of the risk of explosion is protected.

According to one embodiment, the supply line has a bulkhead fitting, which is housed in an orifice in one of the two longitudinal members and which allows the supply line to pass through said longitudinal member. This makes it easier to install the hydrogen circuit, and in particular the supply line when it is intended to connect a tank placed in the chassis to hydrogen-consuming equipment placed in the casing. This also makes it possible to prevent or at least limit the passage of gas between the interior of the chassis and the interior of the casing in the event of a leak from the tank, from the hydrogen-consuming equipment and/or from the hydrogen circuit.

According to one embodiment, the handling machine comprises at least one electric motor, which is configured to move the handling machine or to actuate the load-handling device, and the hydrogen-consuming equipment is a fuel cell that is configured to generate electrical energy intended to supply the electric motor with power.

According to one embodiment, the handling machine has an electrical energy storage device, the fuel cell and the electrical energy storage device being electrically connected, on the one hand, to one another and, on the other hand, in parallel to the electric motor.

According to one embodiment, the electrical energy storage device has one or more batteries and/or one or more supercapacitors.

According to one embodiment, the electrical energy storage device is housed in a housing formed beneath the driver's cab. Such an arrangement makes it possible to separate the electrical energy storage device from the tank and from the fuel cell, thereby moving it away from the hydrogen leaks that may occur and even further limiting the risk of fire. This also isolates the electrical energy storage device from the heat generated by the fuel cell, and thus limits the risk of said electrical energy storage device overheating.

According to one embodiment, the handling machine also comprises a DC-to-DC voltage converter, which is connected, on the one hand, to the fuel cell and, on the other hand, to the electric motor and to the electrical energy storage device.

According to one embodiment, the DC-to-DC voltage converter is housed in a housing formed beneath the driver's cab. This allows the voltage converter to be protected against impacts, and isolated from any hydrogen leaks that may occur inside the chassis or the casing, and from the heat generated by the fuel cell.

According to one embodiment, the at least one tank has the shape of a cylinder of revolution about a central axis, the tank being oriented so that the central axis is parallel to the median longitudinal axis.

According to one embodiment, the handling machine comprises:
a front axle and a rear axle, which are mounted on the chassis transversely to the median longitudinal axis and each have two wheels;
a transmission shaft, which couples the front axle and the rear axle to a motor, the transmission shaft extending inside the chassis, between the two longitudinal members, parallel to the median longitudinal axis of the chassis;
at least two tanks, which are intended to contain hydrogen and are housed in the chassis, between the two longitudinal members, laterally on either side of the transmission shaft. Such an arrangement makes it possible to optimize the volume of hydrogen that may be stored when the transmission of the machine has a transmission shaft that has the abovementioned arrangement.

According to one variant embodiment, the handling machine has at least four tanks, which are intended to contain hydrogen and are housed in the chassis, two of the four tanks having central axes that are arranged above and laterally on either side of the transmission shaft, and the other two tanks having central axes that are arranged below and laterally on either side of the transmission shaft.

According to one embodiment, the handling machine comprises:
a front axle and a rear axle, which are mounted on the chassis transversely to the median longitudinal axis and each have two wheels;
two electric motors, which are respectively coupled to the front axle and to the rear axle via a transmission device and are housed inside the chassis, respectively in front of and to the rear of the at least one tank.

According to one embodiment, the load-handling device has a lifting arm, which is connected in an articulated manner to the two longitudinal members, between said longitudinal members so as to be able to pivot with respect to the two longitudinal members about a transverse pivot axis.

According to one embodiment, the or each tank is fastened to the chassis by means of two collars encircling a cylindrical wall of the tank, each collar having two parts that are fastened to one another by fastening members and one of which is fastened to an element of the chassis, such as a longitudinal member or a crossmember connecting the longitudinal members. Such fastening means of the tank enable the tank to expand or contract in its longitudinal direction.

According to another embodiment, the or each tank has two necks that protrude from each of the two ends of the tank, the tank being fastened to the chassis by means of two mounting supports, which are respectively fastened around each of the two necks.

According to one advantageous variant embodiment, one end of the tank is kept fixed in place with respect to the chassis by means of one of the two mounting supports, whereas the other end is mounted so as to slide with respect to the other mounting support. This enables the tank to expand or contract.

According to one embodiment, the fuel cell is equipped with an air supply compressor and with a humidifier device.

According to one embodiment, the handling machine has a cooling device allowing the fuel cell to be cooled, said cooling device having, for example, a cooling circuit equipped with a heat exchanger, and being housed inside the casing.

According to one embodiment, the handling machine comprises a front axle and a rear axle, which are mounted on the chassis transversely to the median longitudinal axis X and each have two wheels.

According to one embodiment, the driver's cab is situated between the front axle and the rear axle.

According to one embodiment, the casing is situated between the front axle and the rear axle.

According to one embodiment, the handling machine has at least two motors, which are respectively configured to actuate the load-handling device and to move the handling machine.

According to one embodiment, the handling machine has two electric motors, which are respectively coupled to the front axle and to the rear axle via a transmission device.

According to one embodiment, the handling machine has one electric motor, which is coupled to the front axle and to the rear axle via a transmission device.

According to one embodiment, the motor for actuating the load-handling device is a motor that drives a hydraulic pump, the hydraulic pump being connected to one or more hydraulic rams designed to move a lifting arm of the load-handling device.

According to one embodiment, the load-handling device has a lifting arm, which extends in a longitudinal plane between the casing and the driver's cab and which is mounted in an articulated manner on the chassis about a transverse pivot axis P.

According to one embodiment, the lifting arm is a telescopic arm.

According to one embodiment, the handling machine is a telescopic handler.

### BRIEF DESCRIPTION OF THE FIGURES

The invention will be better understood, and further objects, details, features and advantages thereof will become more clearly apparent throughout the following description of a number of particular embodiments of the invention, which are given solely by way of nonlimiting illustration, and with reference to the attached drawings.

FIG. 1 is a schematic view from above of a handling machine according to a first embodiment.

FIG. 2 partially illustrates the handling machine from FIG. 1 and in particular its chassis, and also a tank that is intended to contain hydrogen and that is housed inside said chassis.

FIG. 3 illustrates a tank equipped with fastening means intended to fasten the tank to the chassis according to a first variant embodiment.

FIG. 4 illustrates a tank equipped with fastening means intended to fasten the tank to the chassis according to a second variant embodiment.

FIG. 5 is a schematic view of a hydrogen circuit according to one embodiment.

FIG. 6 is a sectional view of a bulkhead fitting that allows a hydrogen circuit to pass through one of the longitudinal members of the chassis.

FIG. 7 is a similar view to that of FIG. 2, partially illustrating a handling machine according to a second embodiment.

FIG. 8 is a detailed cross-sectional view of the handling machine from FIG. 7 illustrating the arrangement of the tanks in the chassis.

FIG. 9 is a schematic view from above of a handling machine according to a third embodiment.

### DESCRIPTION OF THE EMBODIMENTS

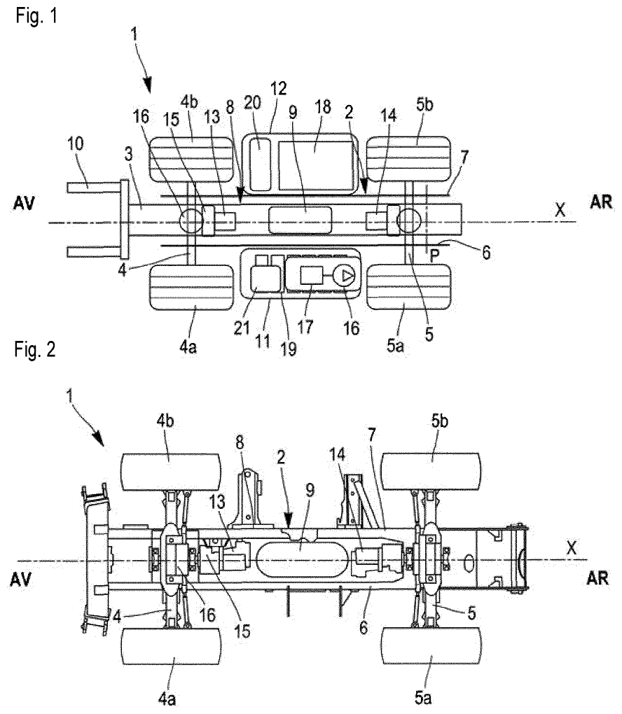

By convention, the “longitudinal” direction of the handling machine corresponds to the front-rear orientation of the machine. Moreover, the terms “rear” and “front”, respectively denoted as “AR” and “AV” in FIGS. 1, 2, 7 and 9, are used to define the relative position of one element with respect to another in the longitudinal direction. The “transverse” direction is oriented perpendicular to the longitudinal direction.

A handling machine 1 according to a first embodiment is described with reference to FIGS. 1 and 2. The handling machine 1 has a chassis 2 and a load-handling device, in this instance a lifting arm 3, which is mounted so as to be able to move on the chassis 2. The lifting arm 3 is, for example, a telescopic arm. In this case, the handling machine 1 may in particular be a telescopic handler.

The chassis 2 is able to move. To this end, the handling machine 1 has two axles: a front axle 4 and a rear axle 5, which are each mounted on the chassis 2 along a transverse axis and are each equipped with two wheels, one on the left 4a, 5a, and the other on the right 4b, 5b. Of the two axles that are the front axle 4 and rear axle 5, at least one is mounted so as to be to rotate about its axis in order to move the chassis. The front axle 4 and rear axle 5 may also be mounted on the chassis with the possibility of deflection about the longitudinal axis so as to compensate for the cant of the handling machine.

The chassis 2 has a pair of longitudinal members 6, 7, which can be seen in FIGS. 1 and 2. The longitudinal members 6, 7 are generally planar, mutually parallel metal components that extend parallel to the median longitudinal axis X, respectively on either side of said median longitudinal axis X. The longitudinal members 6, 7 are connected to one another via crossmembers, which can be seen in FIG. 2, so as to form a space 8 that allows for the housing of components of the handling machine 1, and in particular one or more tanks 9 intended to contain hydrogen, as detailed below. The space 8 is advantageously closed on its upper part by sheet-metal plates, not illustrated, which are fastened to the longitudinal members 6, 7.

As depicted in FIG. 1, the lifting arm 3 extends in a longitudinal plane that is preferably a median plane, i.e. the median longitudinal axis X is included in this plane. The lifting arm 3 is connected in an articulated manner to the two longitudinal members 6, 7, between these, so as to be able to pivot about a transverse pivot axis P. The lifting arm 3 may be embodied in various ways, in particular in the form of several telescopic sections or, as a variant, in the form of a fixed-length arm. One end of the lifting arm 3, the opposite end from the pivot axis P, may bear a working tool 10 or a modular tool holder able to receive several types of working tools 10. A working tool 10 is understood to mean, for example, a pair of forks, a bucket, a winch, a gripper, or the like.

Moreover, the handling machine 1 has a driver's cab 11 in which a driver may be accommodated and which is in particular equipped with a seat, not depicted, and with equipment for controlling the handling machine. The driver's cab 11 is positioned on a first side of the median longitudinal axis X, on the left-hand side in the embodiment depicted, and between the front axle 4 and the rear axle 5. The handling machine 1 also has a casing 12, which is positioned, with respect to the driver's cab 11, on the other side of the median longitudinal axis X of the handling machine 1. More particularly, the casing 12 and the driver's cab 11 are positioned on either side of the pair of longitudinal members 6, 7.

The handling machine 1 has one or more linear actuators, not depicted, such as hydraulic rams, which are each mounted in an articulated manner, on the one hand, on the lifting arm 3 and, on the other hand, on the chassis 2 of the handling machine 1, thus allowing the lifting arm 3 to be pivoted, with respect to the chassis 2, about the pivot axis P. The hydraulic rams are connected to a hydraulic circuit equipped with a hydraulic pump 16, which can be seen in FIG. 1. In the embodiment depicted, the hydraulic pump 16 is driven by a motor, such as an electric motor 17. The hydraulic pump 16 and also the electric motor 17 are in this case housed in a space formed beneath the driver's cab 11.

The handling machine 1 has at least one electric motor, which is configured to move the handling machine 1. In the embodiment depicted in FIG. 1, the handling machine 1 has two electric motors 13, 14, which move said handling machine and are each housed inside the chassis 2, between the two longitudinal members 6, 7. Each electric motor 13, 14 is coupled to one of the front axle 4 and rear axle 5 via a transmission device. Thus, the handling machine 1 has four-wheel drive. In the embodiment depicted, each transmission device has a reduction gear 15 and a differential 16. Alternatively, the transmission device is a hydraulic transmission device.

The handling machine 1 moreover has a power supply system for supplying electrical energy to at least one and preferably all of the abovementioned electric motors 13, 14, 16.

The electrical power supply system has at least one tank 9 intended to store hydrogen, a fuel cell 18 and an electrical energy storage device 19 comprising one or more batteries and/or one or more supercapacitors. The batteries may be of any known type, for example of the lead-acid type or preferably of the lithium-ion type. The electrical energy storage device 19 is connected to the electric motor(s) 13, 14, 16 in parallel with the fuel cell 18.

The tank 9 is, for example, suitable for storing hydrogen in the gaseous state at a maximum pressure of between 300 and 700 bar, for example of the order of 350 bar. According to another variant embodiment, the tank 9 is suitable for storing hydrogen in the solid state in the form of metal hydrides. According to yet another variant embodiment, the tank 9 is suitable for storing hydrogen in the liquid state.

As illustrated in FIGS. 1 and 2, the tank 9 is housed in the chassis 2 of the handling machine, i.e. in the space 8 formed between the two longitudinal members 6, 7. Such an arrangement of the tank 9 offers it excellent protection against falling objects and lateral impacts, thereby making it possible to considerably limit the risk of the tank 9 exploding. In the embodiment depicted, the tank 9 has the shape of a cylinder of revolution. Furthermore, the tank 9 is preferably oriented so that the generatrices of the cylinder of revolution are oriented parallel to the longitudinal direction of the handling machine 1. Preferably, the tank 9 is furthermore arranged between the front axle 4 and the rear axle 5 and between the two electric motors 13, 14. The tank 9 typically has a volume of between 50 and 300 liters, for example of the order of 100 liters.

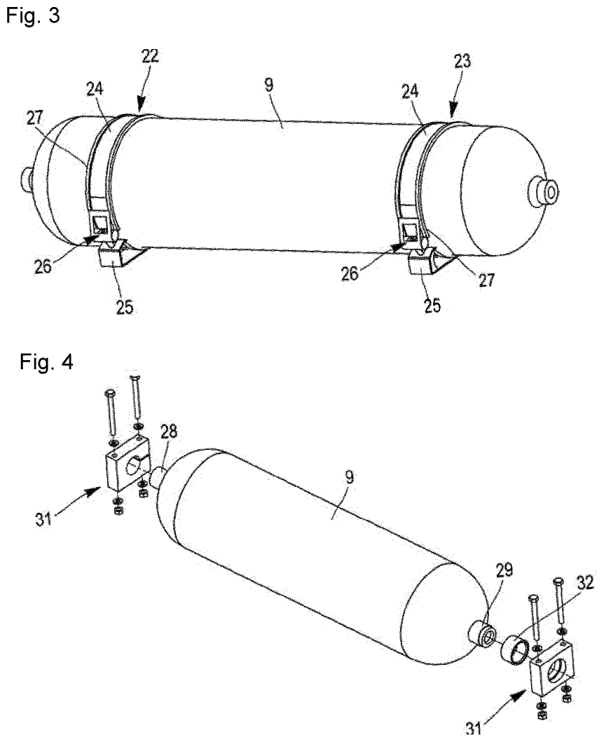

According to one variant embodiment, which is depicted in FIG. 3, the tank 9 is fastened to the chassis 2 by means of two collars 22, 23. The two collars 22, 23 encircle the cylindrical wall of the tank 9, respectively in proximity to each of the two ends of the tank 9. In FIG. 6, each collar 22, 23 has two portions 24, 25 that are secured to one another using fastening members 26. One of the portions, in this case the one referenced 24, is fastened to a non-depicted element of the chassis 2, for example to one of the longitudinal members 6, 7 or to a crossmember connecting the two longitudinal members 6, 7. Advantageously, an elastomeric strip 27 is interposed radially between each collar 22, 23 and the tank 9. Such fastening means enable the tank 9 to contact or expand.

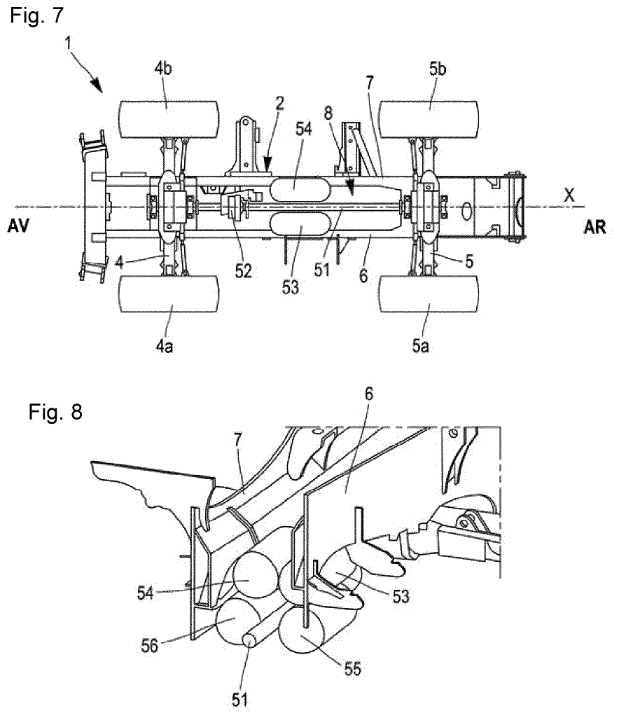

FIG. 7 depicts means for fastening the tank 9 to the chassis 2 according to another variant embodiment. The tank 9 has two necks 28, 29 protruding from each of its two ends. The tank 9 is fastened to the chassis 2 by means of two mounting supports 30, 31, which are respectively mounted around each of the two necks 28, 29 and which are each fastened to an element of the chassis 2, which cannot be seen in FIG. 7, for example to one of the longitudinal members 6, 7 or to a crossmember connecting the two longitudinal members 6, 7. One end of the tank 9 is kept fixed in place with respect to the chassis 2 by means of one of the two mounting supports 30, whereas the other end is mounted so as to slide with respect to the other mounting support 31, thereby enabling the tank to expand or contact. To this end, one of the necks 29 of the tank 9 is mounted so as to slide inside a ring that is fastened to the second mounting support 31. The ring 32 is, for example, manufactured from a plastics material with a low coefficient of friction, such as polyethylene.

FIG. 7 illustrates a hydrogen circuit according to one embodiment. The hydrogen circuit has a filling line 33, which is equipped with a neck 34 intended to receive a filling nozzle of a hydrogen fueling station and which leads to an inlet valve 35 of the tank 9 through a non-return valve 36. The hydrogen circuit also has a supply line 37, which is intended to conduct the hydrogen from the tank 9 to the fuel cell 18. The supply line 37 has a filter 58 and a pressure regulator 38, which makes it possible to decrease the pressure in order to supply the fuel cell 18 with hydrogen that has a pressure that is compatible with operation thereof, i.e. lower than the pressure at which it is stored in the tank 9. By convention, the portion of the supply line 37 that is arranged upstream of the pressure regulator 38 is designated the high-pressure portion 39 whereas the portion arranged downstream thereof is designated the low-pressure portion 40.

Moreover, the hydrogen circuit has a drain circuit 41 that allows the contents of the tank 9 to be drained, in particular in an emergency. To this end, the drain circuit 41 is connected to a bleeder valve 42 of the tank 9.

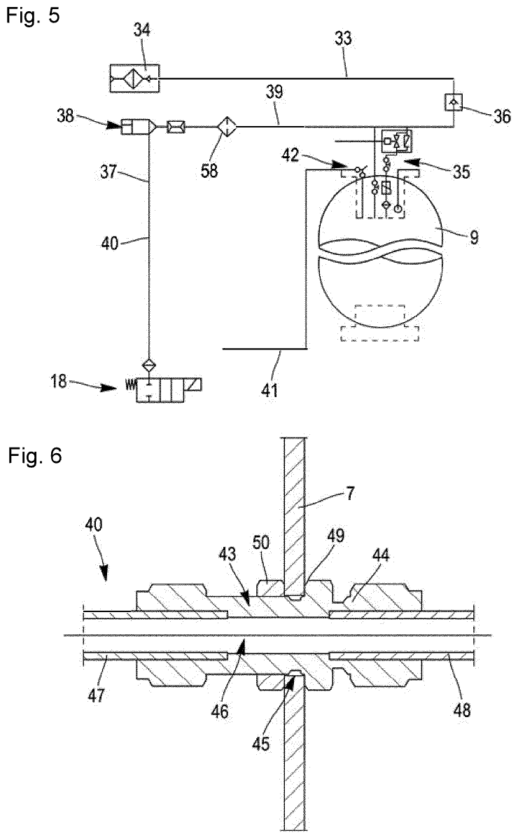

Returning to FIGS. 1 and 2, it can be seen that the fuel cell 18 is advantageously housed inside the casing 12. This arrangement thus makes it possible to separate the tank 9 from the fuel cell 18 and thus to limit the risk of the tank 9 catching fire. Moreover, likewise for safety reasons, the pressure regulator 38, illustrated in FIG. 5, is housed inside the chassis 2. Thus, the portion of the supply line 37 that is most critical in terms of risk of explosion, namely its high-pressure portion 39, is housed inside the chassis 2 and is consequently the best protected portion. By contrast, only the portion of the loading line that is least critical in terms of risk of explosion, namely the low-pressure portion 40, extends within the casing 12 and as such has less protection.

Advantageously, the low-pressure portion 39 of the supply line 37 passes through one of the longitudinal members 6, 7 of the chassis 12 in order to connect the tank 9 and the pressure regulator 38, which are housed inside the chassis 2, on the one hand, to the fuel cell 18 housed in the casing 12, on the other hand. To this end, the supply line 37 has, advantageously, a bulkhead fitting 43, illustrated in FIG. 6. The bulkhead fitting 43 has a body 44 that is designed to engage inside an opening 45 formed in the longitudinal member 7. The body 44 of the bulkhead fitting 43 has a channel 46 that is connected to an upstream part 47 and to a downstream part 48 of the low-pressure portion 40. The body 44 of the bulkhead fitting 43 also has a bearing surface 49 that comes into contact against one side of the longitudinal member 7, whereas another element 50, such as a nut, is fastened to the body 44 and comes into contact against the other side of the longitudinal member 7, thereby making it possible to fasten the bulkhead fitting 43 to said longitudinal member 7.

As is known per se, the fuel cell 18 is where an oxidation-reduction reaction takes place that converts the hydrogen from the tank 9, and the oxygen from the air supplied by the compressor, into electricity, water and heat. In addition, returning to FIG. 1, it can be seen that the handling machine 1 also has a cooling device 20, which can be seen in FIG. 1, that allows the fuel cell 18 to be cooled. The cooling device 20 is likewise housed inside the casing 12. According to one embodiment, the cooling device 20 has a cooling circuit equipped with a heat exchanger.

Moreover, the fuel cell 18 is also equipped with an air supply compressor allowing the oxidant air at the inlet to the cells of the fuel cell 18 to be compressed. The fuel cell 18 may also have a humidifier device allowing the air at the inlet to the fuel cell 18 to be humidified.

The handling machine 1 may also have a water-collection device, not depicted, able to collect the water discharged by the fuel cell 18. Moreover, the water-collection device may be connected to a water discharge orifice that allows the water to be discharged or to a tank allowing the water to be stored. The water-collection device may be connected to the humidifier device in order to supply the latter with water.

The handling machine 1 also has power electronics, which have in particular a DC-to-DC voltage converter 21, which is connected, on the one hand, to the fuel cell 18 and, on the other hand, to the electric motors 13, 14, 17 and to the electrical energy storage device 19. The DC-to-DC voltage converter 21 is able to convert the level of voltage delivered by the fuel cell 18 to the level of voltage required by the electric motors 13, 14, 17 and the electrical energy storage device 19.

The handling machine 1 also has control means, not illustrated, which are configured to control the fuel cell 18, the electric motors 13, 14, 17 and the DC-to-DC voltage converter 21 on the basis of command signals delivered by the controls of the handling machine 1, such as a throttle pedal and/or a control joystick, in particular.

The electrical energy storage device 19 and the DC-to-DC voltage converter 21 are housed on the other side of the chassis 2 with respect to the casing 12, i.e. on the side of the driver's cab 11. The electrical energy storage device 19 and the DC-to-DC voltage converter 21 are, for example, housed in a housing formed beneath the driver's cab 11. Such an arrangement is advantageous in that it allows the electronics to be isolated from hydrogen leaks that may occur, inside the casing 12 or the chassis 2, thereby even further limiting the risk of fire. This arrangement also allows the electrical energy storage device to be isolated from the heat generated by the fuel cell, thereby limiting the risk of said electrical energy storage device overheating. Finally, this arrangement may contribute to better lateral balancing of the handling machine 1.

In one non-depicted embodiment, the handling machine 1 has a secondary chassis that is mounted so as to rotate about a vertical axis of rotation on the abovementioned chassis 2. In such an embodiment, the casing 12, the driver's cab 11 and the housing, which is formed beneath the driver's cab 11 and in which the electrical energy storage device 19 and the DC-to-DC voltage converter 21 are arranged, are fastened to the secondary chassis. Furthermore, the load-handling device, i.e. the lifting arm 3, is mounted in an articulated manner on the secondary chassis.

FIGS. 3 and 4 illustrate a handling machine according to another embodiment. This embodiment differs from the one described above in relation to FIGS. 1 and 2 in that a transmission shaft 51, which is coupled to a motor, for example an electric motor, not depicted, via a reduction gear 52 and which connects the front axle 4 and the rear axle 5. The transmission shaft 51 extends inside the chassis 2, parallel to the longitudinal direction, and substantially in the center of the chassis 2, i.e. along the median longitudinal axis X. Such a transmission shaft 51 makes it possible to drive the four wheels 4a, 4b, 5a, 5b using just one motor. The motor may also be arranged inside the chassis 2.

In such an embodiment, the handling machine 1 has at least two tanks 53, 54, 55, 56 distributed laterally on either side of the transmission shaft 51 in order to conserve sufficient hydrogen storage capacity. In FIG. 4, it can be seen that the handling machine 1 has four tanks 53, 54, 55, 56. Two of the tanks 53, 54 have central axes that are arranged above the transmission shaft 51, laterally on either side thereof, whereas the other two tanks 55, 56 have central axes that are arranged below the transmission shaft 51, laterally on either side thereof. As in the embodiment of FIGS. 1 and 2, the tanks 53, 54, 55, 56 have the shape of a cylinder of revolution. The tanks 53, 54, 55, 56 are preferably oriented so that the generatrices of the cylinder of revolution are oriented parallel to the longitudinal direction of the handling machine 1.

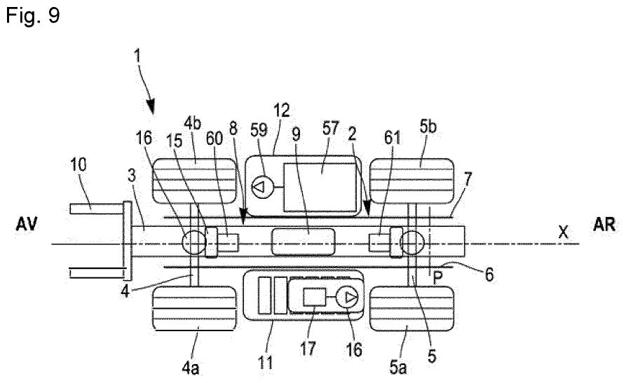

FIG. 9 depicts a handling machine according to another embodiment. In this embodiment, the engine that is configured to move the handling machine is a hydrogen internal combustion engine 57. Such engines are generally denoted by the acronym HICE. The hydrogen internal combustion engine 57 is arranged in place of the fuel cell 18 in the preceding embodiments, i.e. in the casing 12. This arrangement thus makes it possible to separate the internal combustion engine 18 from the tank 9, thereby limiting the risk of the tank 9 catching fire. As in the embodiment illustrated in FIG. 6, the supply line 37 of the hydrogen circuit passes through one of the longitudinal members 7 by means of a bulkhead fitting 43 in order to connect the tank 9 and the pressure regulator 38, which are housed inside the chassis 2, to the hydrogen internal combustion engine 57, which is housed in the casing 12. Similarly, the portion of the loading line 37 that is most critical in terms of risk of explosion, namely its high-pressure portion 39, is housed inside the chassis 2. The internal combustion engine 37 is coupled to at least one of the front axle 4 and rear axle 5 and advantageously to both axles via one transmission device. In FIG. 9, this transmission device has a hydraulic pump 59, which is coupled to the hydrogen internal combustion engine 57 and which is housed in the casing 12. The hydraulic pump 59 is hydraulically connected to two hydraulic motors 60, 61, which are respectively coupled to the front axle 4 and to the rear axle 5.

In one non-depicted alternative embodiment, the hydrogen internal combustion engine 57 may also be coupled to the front axle 4 and rear axle 5 via a transmission shaft 51, as described above in relation to FIG. 3.

According to another non-depicted variant embodiment, the hydrogen internal combustion engine 57 is not used to move the vehicle but is associated with a current generator so as to produce electrical energy. The current generator is connected to the electrical energy storage device and/or to the electric motor(s) intended to move the vehicle.

Although the invention has been described in connection with several particular embodiments, it is quite obvious that it is in no way limited thereto and that it comprises all the technical equivalents of the means described and also combinations thereof where these fall within the scope of the invention as defined by the claims.

The use of the verbs “have”, “comprise” or “include” and the conjugated forms thereof does not exclude the presence of elements or steps other than those listed in a claim.

In the claims, any reference sign between parentheses should not be interpreted as a limitation on the claim.

1. A handling machine (1) having:
a chassis (2) having a median longitudinal axis (X) and comprising two longitudinal members (6, 7) extending on either side of the median longitudinal axis (X);
a load-handling device, which is mounted so as to be able to move on the chassis (2);
a driver's cab (11), which is fastened to the chassis (2) and is positioned on a first side of the chassis (2) with respect to the median longitudinal axis (X) of the chassis (2); and
at least one tank (9, 53, 54, 55, 56), which is intended to contain hydrogen; and
a hydrogen-consuming equipment, which is connected to the tank (9, 53, 54, 55, 56) via a supply line (37) and which is selected from among a fuel cell (18) and a hydrogen internal combustion engine (57), the handling machine (1) being characterized in that:
the tank (9, 53, 54, 55, 56) is housed in the chassis (2), between the two longitudinal members (6, 7); and the handling machine (1) comprises a casing (12), which is fastened to the chassis (2) and is arranged on a second side of the chassis (2), opposite the first side, with respect to the median longitudinal axis (X) and wherein the hydrogen-consuming equipment is housed in the casing (12).

2. (canceled)

3. (canceled)

4. The handling machine (1) as claimed in claim 1, wherein the supply line (37) that connects the tank (9, 53, 54, 55, 56) to the hydrogen-consuming equipment has a pressure regulator (38) and wherein the pressure regulator (38) and also an upstream portion (39) of the supply line (37) that connects the pressure regulator (38) to the tank (9, 53, 54, 55, 56) are housed in the chassis (2), between the two longitudinal members (6, 7).

5. The handling machine (1) as claimed in claim 1 or claim 4, wherein the supply line (37) has a bulkhead fitting (43), which is housed in an orifice (45) in one of the two longitudinal members (6, 7) and which allows the supply line (37) to pass through said longitudinal member (6, 7).

6. The handling machine (1) as claimed in claim 1, claim 4 or claim 5, also comprising at least one electric motor (13, 14, 17), which is configured to move the handling machine (1) or to actuate the load-handling device, and wherein the hydrogen-consuming equipment is a fuel cell (18) that is configured to generate electrical energy intended to supply the electric motor (13, 14, 17) with power.

7. The handling machine (1) as claimed in claim 6, also having an electrical energy storage device (19), the fuel cell (18) and the electrical energy storage device (19) being electrically connected, on the one hand, to one another and, on the other hand, in parallel to the electric motor (13, 14, 17).

8. The handling machine (1) as claimed in claim 7, wherein the electrical energy storage device (19) is housed in a housing formed beneath the driver's cab (11).

9. The handling machine (1) as claimed in claim 7 or 8, also comprising a DC-to-DC voltage converter (21), which is connected, on the one hand, to the fuel cell (18) and, on the other hand, to the electric motor (13, 14, 17) and to the electrical energy storage device (19).

10. The handling machine (1) as claimed in claim 9, wherein the DC-to-DC voltage converter (21) is housed in a housing formed beneath the driver's cab (11).

11. The handling machine (1) as claimed in claim 1, or claims 4 to 10, wherein the at least one tank (9, 53, 54, 55, 56) has the shape of a cylinder of revolution about a central axis, the tank (9, 53, 54, 55, 56) being oriented so that the central axis is parallel to the median longitudinal axis X.

12. The handling machine (1) as claimed in claim 1, or claims 4 to 11, comprising:
a front axle (4) and a rear axle (5), which are mounted on the chassis (2) transversely to the median longitudinal axis X and each have two wheels (4a, 4b, 5a, 5b);
a transmission shaft (51), which couples the front axle (4) and the rear axle (5) to a motor, the transmission shaft (51) extending inside the chassis (2), between the two longitudinal members (6, 7), parallel to the median longitudinal axis (X) of the chassis (2);
at least two tanks (53, 54, 55, 56), which are intended to contain hydrogen and are housed in the chassis (2), between the two longitudinal members (6, 7), laterally on either side of the transmission shaft (51).

13. The handling machine (1) as claimed in claim 12, having at least four tanks (53, 54, 55, 56), which are intended to contain hydrogen and are housed in the chassis (2), two of the four tanks (53, 54) having central axes that are arranged above and laterally on either side of the transmission shaft, and the other two tanks (55, 56) having central axes that are arranged below and laterally on either side of the transmission shaft (51).

14. The handling machine (1) as claimed in claim 1, or claims 4 to 11, comprising:
a front axle (4) and a rear axle (5), which are mounted on the chassis (2) transversely to the median longitudinal axis X and each have two wheels (4a, 4b, 5a, 5b);
two electric motors (13, 14), which are respectively coupled to the front axle (4) and to the rear axle (5) via a transmission device and are housed inside the chassis (2), respectively in front of and to the rear of the at least one tank (53, 54, 55, 56).

15. The handling machine (1) as claimed in claim 1, or claims 4 to 14, wherein the load-handling device has a lifting arm (3), which is connected in an articulated manner to the two longitudinal members (6, 7), between said longitudinal members (6, 7) so as to be able to pivot with respect to the two longitudinal members (6, 7) about a transverse pivot axis (P).
